(19) United States
(12) Patent Application Publication
(10) Pub. No.: US 2013/0316833 A1
(43) Pub. Date: Nov. 28, 2013

(54) SYSTEMS AND METHODS OF GENERATING A USER GENERATED BETTING MARKET IN AN ONLINE BETTING EXCHANGE

(71) Applicant: Sham Dadlani, Essex (GB)

(72) Inventor: Sham Dadlani, Essex (GB)

(73) Assignee: IBETX LTD., Essex (GB)

(21) Appl. No.: 13/481,414

(22) Filed: May 25, 2012

(51) Int. Cl. G06F 17/00

(52) U.S. Cl. 463/42

(57) ABSTRACT

A computer-implemented method of generating a user generated betting market in an online betting exchange, the online betting exchange comprising a plurality of exchange generated betting markets, the method being implemented in a computer comprising a processor and a memory in communication with the processor. The method comprises providing, by the processor, a user interface to a user of the betting exchange, the user interface allowing the user to input data associated with the user generated betting market to be generated, receiving, as input to the processor, user input by the user interface, and processing, by the processor, said user input to generate said user generated betting market

### TECHNICAL FIELD

The present disclosure relates to systems and methods of generating a user generated betting market in an online betting exchange.

### BACKGROUND

Online betting exchanges allow users of the betting exchange to place bets against other individuals in markets provided and managed by the betting exchange. The users can specify their own odds which can be accepted by other users if the other users consider the offered odds to be acceptable. Such betting exchanges have created competition for the traditional bookie where a “bookie” offers odds which may be accepted by bettors and have provided greater flexibility for bettors with considerable success.

However there is still a need for improved betting exchanges.

### SUMMARY

It is an object of the present disclosure to provide improvements in systems and methods for online betting exchanges.

According to a first aspect there is provided a computer-implemented method of generating a user generated betting market in an online betting exchange, the online betting exchange comprising a plurality of exchange generated betting markets, the method being implemented in a computer comprising a processor and a memory in communication with the processor. The method comprises providing, by the processor, a user interface to a user of the betting exchange, the user interface allowing the user to input data associated with the user generated betting market to be generated, receiving, as input to the processor, user input by the user interface and processing, by the processor, said user input to generate said user generated betting market.

By providing a user interface to a user of the betting exchange that allows a user to input data for the generation of a user generated betting market in this way, users are able to generate and customize markets. As such a more flexible and interactive betting exchange is provided.

The method may further comprise generating a user interface associated with the user generated betting market. The user interface can be used by the user and other users of the betting exchange to offer and accept bets on the user generated betting market as well as the exchange generated betting markets.

The input data may include a user commission, and the user may receive a value of at least some bets placed in the user generated betting market based upon the user commission. That is, the user that creates the user generated betting market can receive a payment based upon at least some of the bets placed in the user generated betting market. In this way users of the betting exchange can effectively run and profit from their own user betting exchange facilitated by the betting exchange.

The user input may indicate at least one exchange generated betting market upon which the user generated getting market is to be based, and processing the user input to generate the user generated betting market may comprise copying data from the at least one exchange generated betting market. For example, a user may base a user generated betting market on an exchange generated betting market but may include additional rules. An outcome of the user generated betting market may be determined based upon the at least one exchange generated betting market.

The user input data may comprise an outcome for the user generated betting market and the user generated betting market may allow at least some users of the betting exchange to place bets on the outcome. For example the outcome may be a result between two or more contestants such as local teams, candidates, for example political candidates, or any type of contestants between which there is an outcome that can be bet upon. In general user input contestants, or at least the outcome for which the user generated betting market is generated between the contestants, are otherwise not available to be bet upon in an exchange generated betting market. The input data may comprise a source for the result of the market, for example an independent source other than the user that can be used to verify the outcome.

The method may further comprise receiving, as input to the processor, access data indicating at least one user of the online betting exchange and restricting, by the processor, access to the user generated betting market based upon the access data. The access data may comprise input from the user such as an indication of other users that are permitted to use the user generated betting market.

The method may further comprise generating, by the processor, identification data associated with the user generated betting market and the access data indicating at least one user of the online betting exchange may be generated based upon the identification data. For example the identification data may comprise a password that can be used to access the user generated betting market and/or the identification data may comprise a link to the user generated betting market. The user that generates the user generated betting market may then distribute the identification data in order to provide access to the user generated betting market.

The user input data may comprise data indicating a type of bet that can be placed by users of the user generated betting market. The type of bet may be a type selected from the group consisting of: a bet for an outcome (sometimes referred to as a back bet), a bet against an outcome (sometimes referred to as a lay bet), a bet with only one other user, a bet with one or more other users.

The user input data may comprise data indicating a first type of bet that can be placed by the user that generates the user generated betting market and a second, different type of bet that can be placed by other users of the user generated betting market. For example, the user that generates the user generated betting market may restrict other users to placing back bets in the betting market such that the user that generates the betting market effectively operates the market as a conventional bookie and sets the odds available for betting in the market.

The method may further comprise receiving, by the processor, market type data from the user and the user interface may comprise a template based upon the market type data. For example, the user may specify that the market is a cricket market and a template may be provided to allow data required for generating a cricket betting market to be input.

The user generated betting market may have an associated exchange commission, and the exchange may receive a value of at least some bets placed in the generated betting market based upon said exchange commission. The method may further comprise receiving a payment from the user in respect of the user generated betting market and reducing the exchange commission based upon the payment from the user. That is, whilst the betting exchange may typically charge a commission for the user generated betting market, the user may pay to reduce or remove the betting exchange commission. The user may then charge a similar commission to the normal betting exchange commission such that the market is not less desirable to place bets in due to a greater commission than markets that are not user generated.

Aspects of the present disclosure can be implemented in any convenient form. For example computer programs may be provided to carry out the methods described herein. Such computer programs may be carried on appropriate computer readable media which term includes appropriate non-transient tangible storage devices (e.g. discs). Aspects of the present disclosure can also be implemented by way of appropriately programmed computers and other apparatus.

### BRIEF DESCRIPTION OF THE SEVERAL VIEWS OF THE DRAWINGS

The accompanying drawings, which are incorporated in and constitute part of this specification, illustrate embodiments of the present disclosure and together with the description serve to explain the principles of the present disclosure. The embodiments illustrated herein are presently preferred, it being understood, however, that the present disclosure is not limited to the precise arrangements and instrumentalities shown, wherein:

FIG. 1 is a schematic illustration of part of an exemplary network suitable for carrying out embodiments of the present disclosure;

FIG. 1A is a schematic illustration of an exemplary exchange server of the exemplary network of FIG. 1; and

FIG. 2 is an example of a user interface for a betting market in a betting exchange;

FIG. 3 shows an exemplary user interface for a betting exchange generated betting market based upon the exemplary user interface of FIG. 2; and

FIG. 4 shows the exemplary steps of any example method carried out by the exchange server.

### DETAILED DESCRIPTION

The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of difference configurations, all of which are explicitly contemplated herein. Further, in the foregoing description, numerous details are set forth to further describe and explain one or more embodiments. These details include system configurations, block module diagrams, flowcharts (including transaction diagrams), and accompanying written description. While these details are helpful to explain one or more embodiments of the disclosure, those skilled in the art will understand that these specific details are not required in order to practice the embodiments.

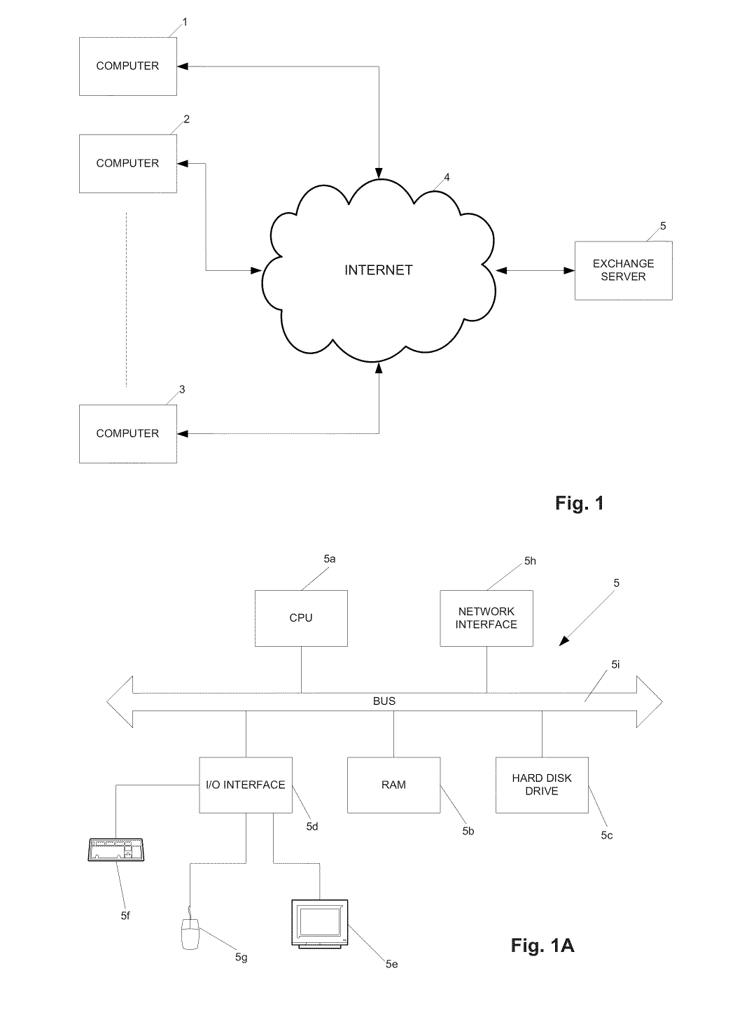

Referring first to FIG. 1 an arrangement for allowing generation of user generated betting markets in an online betting exchange is shown in which a plurality of computers 1, 2, 3 are each arranged to communicate with the Internet 4 and can communicate with other ones of the plurality of computers 1, 2, 3 via the Internet 4. The plurality of computers 1, 2, 3 can additionally communicate with an exchange server 5. The exchange server 5 is arranged to provide an interface for users of the plurality of computers 1, 2, 3 to bet against users of other ones of the plurality of computers 1, 2, 3. The interface allows users to place bets in exchange generated betting markets that are generated by the exchange. Additionally, the interface allows users to generate user generated betting markets, as described below.

FIG. 1A shows the exchange server 5 of the system of FIG. 1 in further detail. It will be appreciated that each of computers, 1, 2, 3 has the general architecture shown in FIG. 1A. It can be seen that the exchange server comprises a CPU 5a which is configured to read and execute instructions stored in a volatile memory 5b which takes the form of a random access memory. The volatile memory 5b stores instructions for execution by the CPU 5a and data used by those instructions. For example, in use, data associated with both exchange generated betting markets and user generated betting markets is stored in the volatile memory 5b.

The exchange server 5 further comprises non-volatile storage in the form of a hard disc drive 5c. The data associated with exchange generated betting markets and user generated betting markets may be stored on the hard disc drive 5c. The exchange server 5 further comprises an I/O interface 5d to which are connected peripheral devices used in connection with the exchange server 5. More particularly, a display 5e is configured so as to display output from the exchange server 5. The display 5e may, for example, display a representation of the interface for users of the plurality of computers 1, 2, 3. Additionally, the display 5e may display the exchange generated betting markets and the user generated betting markets. Input devices are also connected to the I/O interface 5d. Such input devices include a keyboard 5f and a mouse 5g which allow user interaction with the exchange server 5. A network interface 5h allows the exchange server 5 to be connected to an appropriate computer network so as to receive and transmit data from and to other computing devices. The CPU 5a, volatile memory 5b, hard disc drive 5c, I/O interface 5d, and network interface 5h, are connected together by a bus 5i.

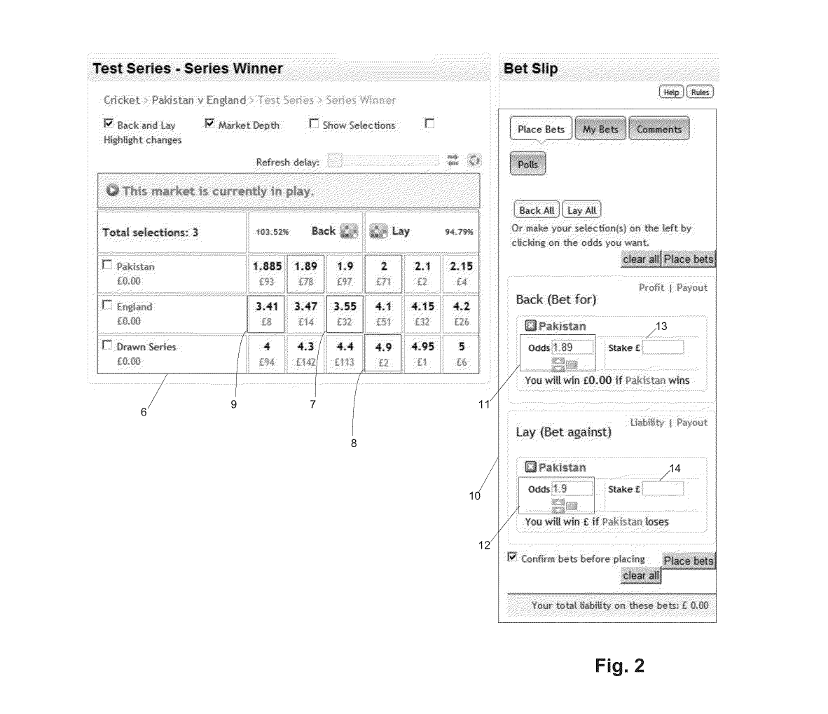

Referring to FIG. 2 a user interface for a betting market on a cricket match between Pakistan and England is shown. The user interface includes a market information area 6 indicating an amount of money in the market for back bets, that is bets that a result will occur, and lay bets, that is bets that a result will not occur, for different possible outcomes of the match. For example, a box 7 indicates that, based upon other lay bets made by other users of the betting exchange, up to £32 can be bet to back England to win with decimal odds of 3.55 and a box 8 indicates that, based upon other bets made by other users of the betting exchange, up to £2 can be laid, or bet against, a drawn series with decimal odds of 4.9.

Boxes indicating decimal odds that are less than other odds indicated for the same result such as box 9 which indicates odds of 3.41 for England to win compared to odds shown in box 7 of 3.55 for England to win indicate the depth of the market and show an amount of money offered by other users of the site at odds different to the best currently available odds.

Users offer bets using a bet slip 10 that allows a user to offer either a back or lay bet at odds specified by the user using odds entry boxes 11, 12 and for a stake specified by the user using stake entry fields 13, 14. If a user offers a bet for which a corresponding offer already exists then the bet is matched with the existing offered bet and the bet cannot then be withdrawn. For example, if the user offers a bet in the market shown in FIG. 2 to back England at odds of 3.55 for a stake of up to £32 then the bet will be matched with existing unmatched lay offers shown in box 7. If the user offers a bet for which no corresponding offer already exists the betting exchange stores the bet until a corresponding bet is received or until the user withdraws the bet.

In general, offers of bets that are at less favourable odds than an existing offer will be automatically adjusted to match the more favourable existing bet and as such an offer that is less than the current best offer will be matched only when all bets at better odds than the bet are matched or withdrawn. For example, the lay bet shown in box 9 described above would generally only be met when £32 of back bets at odds of 3.55 and £14 of back bets at 3.47 have first been matched with the existing lay bets, or when the existing lay bets have been withdrawn.

The user interface of FIG. 2 therefore allows users of the betting exchange to bet on exchange provided and managed betting markets with other users of the betting exchange and the betting exchange displays bets offered by users of the betting exchange using the user interface, and facilitates the matching of corresponding back and lay bets and the betting exchange typically receives a commission from the bets placed in the betting exchange or a subset of the bets placed in the betting exchange, for example a commission on winning bets. In such a system the betting exchange simply facilitates the matching of bets between users in markets determined by the betting exchange.

The present disclosure provides an improved betting exchange in which users are able to create and manage two general categories of market. A user generated closed only market (UGCOM) is created by a user based upon markets generated and managed by the betting exchange, for example as shown in FIG. 2, but which can only be used by the user that creates the market and other users that are invited to the market by the user that creates the market. UGCOMs therefore allow a user to bet on popular events with a subset of users of the betting exchange, for example with friends and family of the user. A user generated open market (UGOM) is created by a user independently of any market created by the betting exchange and may be open either to all users of the betting exchange or may be open to only a subset of users of the betting exchange as for the UGCOM markets. Where a market is open to all users of the betting exchange the market may be searchable by other users of the betting exchange, for example based upon criteria such as sport or details of the creator of the market.

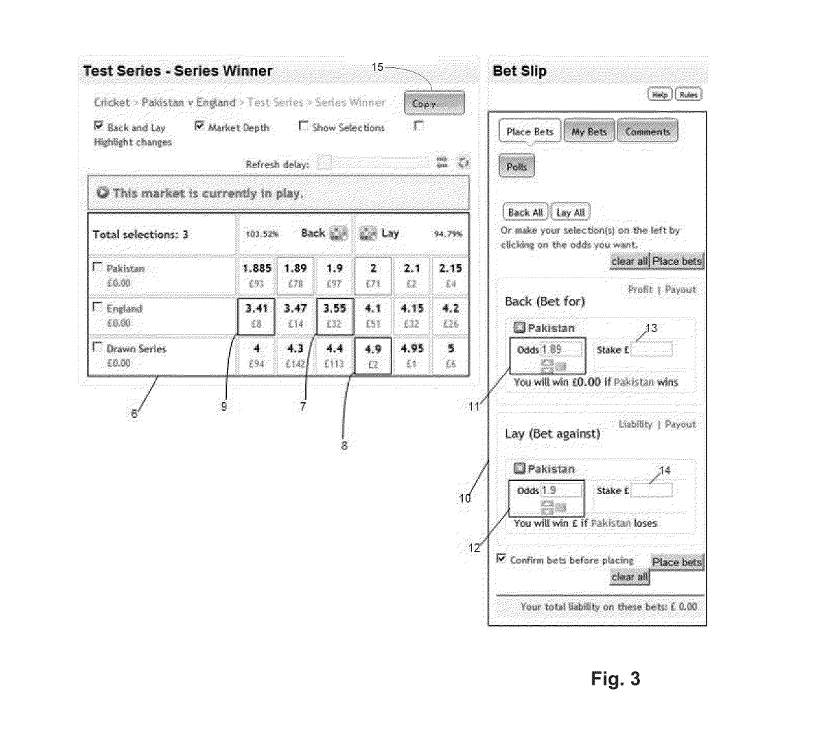

FIG. 3 shows a user interface for a betting exchange generated betting market based upon the user interface of FIG. 2 that allows a user to create a UGCOM using a copy button 15. Upon selection of the button 15 by a user, a copy of the market associated with the user is created. The copy of the market includes copies of the outcomes that are available to bet on in the exchange generated betting market and is linked to the exchange generated betting market for the purposes of determining the result of any subsequent bets that are placed in the copy of the market. Bets may be offered in the UGCOM only by users that are invited to the UGCOM by the creator of the market and as such bets offered in the exchange generated betting market that is copied are not available in the UGCOM. The UGCOM may be customized to specify additional rules and/or features of the copy of the market as described in further detail below.

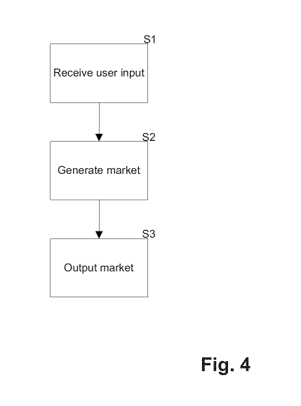

As indicated above, users may additionally create UGOMs that are independent of exchange generated betting markets, that is that are not related to a market that exists on the betting exchange that has been created by the betting exchange. FIG. 4 shows steps carried out by the exchange server 5 to create a UGOM. At step S1 user input associated with the UGOM is received. The user input is received by way of a user interface provided by the exchange server 5, for example a webform on a webpage and includes a name for the market, a description of the market, a start and end time for the market, contestants for the market and a source for the result of the market.

For example, if a user wishes to create a market for city of Ottawa mayoral elections the user inputs a suitable name and description and a start and end time based upon the start and end time of the elections, each candidate in the mayoral elections and a source for the result such as the official city of Ottawa website. The source for the result provides an independent source from which third parties such as other users offering bets in the market can determine the outcome of the market, for example the official city of Ottawa website. A user input may specify multiple result sources such as local daily newspapers and relevant websites. The user input may additionally include other data associated with the market such as a commission that the user creating the market receives on bets, a type of the market and access to the market as described in further detail below.

At step S2 the exchange server 5 processes the user input to generate a market as specified by the user input and at step S3 the exchange server 5 makes the generated market available on the betting exchange, for example by providing a user interface for receiving bets for the generated market in accordance with the user input. Where the user input specifies access to the market the market is made available in accordance with the user specified access. For example, access to a UGOM may be available to any user of the betting exchange or alternatively may be restricted to only those users invited by the user that created the market.

As indicated above, access to UGCOMs are always restricted to only those users that are invited to the market by the creator of the market. Additionally UGOMs may be created such that access to the market is restricted in a corresponding way. Users may be invited to access restricted markets in any convenient way. For example, the creator may search the betting exchange for users that the creator wishes to invite to the market, for example by name or based upon a criterion. Additionally or alternatively a link associated with the access restricted market may be provided to the creator that directs individuals to the market and allows the individuals to access the market. Where the individual is not already a user of the betting exchange the individual may first be provided with a sign up page for becoming a user of the betting exchange and upon completion of sign up the individual may be directed to the access restricted market. In this way a creator of a betting market can direct friends to the access restricted market. The creator may additionally allow users that are invited to join a market to invite other users.

The betting exchange may provide a plurality of templates for the creation of UGOMs. For example, the betting exchange may provide a cricket match template that allows a user to include markets for the cricket match such as a final result market, a wickets market, an individual player runs scored market and/or a ball-by-ball market. The template may be for example a form including a predefined set of inputs that are required from the user in order to create the particular market.

Each of the UGCOM and UGOM allow the creator of the market to specify various aspects of the market as will now be described.

As indicated above, the betting exchange charges a commission on bets, typically a small percentage of winning bets. When a user creates a market the user may specify a creator commission additional to the betting exchange commission such that the creator of a market receives a percentage of all winning bets. The user may of course specify a commission of zero such that only the betting exchange commission is charged. Alternatively, the creator of the market may be provided with an option to buy the market for a fixed price such that the betting exchange does not charge a commission and only the creator's commission, if any, is charged on the market.

The type of betting between users of the market may be specified by the creator. The default, for example, the market may be specified as 1 to 1 such that bets are offered by one layer and accepted by one backer, or offered by one backer and accepted by one layer, on the basis of the total bet that is offered. Alternatively the market may be specified as 1 to many such that only the creator of the market is able to back bets layed by other users, or alternatively the creator of the market is able to lay against back bets offered by other users. In this way a user can create a market in which the creator acts in the same way as a traditional bookie in that the creator offers odds which can be accepted by other users who have access to the market. Further in the alternative the market may be specified as many to many such that all users may offer both back and lay bets which may be accepted either in total or in part by other users.

Although specific embodiments of the present disclosure have been described above, it will be appreciated that various modifications can be made to the described embodiments without departing from the spirit and scope of the present disclosure. That is, the described embodiments are to be considered in all respects exemplary and non-limiting. In particular, where a particular form has been described for particular processing, it will be appreciated that such processing may be carried out in any suitable form arranged to provide suitable output data.

The foregoing is illustrative only and is not intended to be in any way limiting. Reference is made to the accompanying drawings, which form a part hereof. In the drawings, similar symbols typically identify similar components, unless context dictates otherwise.

Note that the functional blocks, methods, devices and systems described in the present disclosure may be integrated or divided into different combination of systems, devices, and functional blocks as would be known to those skilled in the art.

In general, it should be understood that the circuits described herein may be implemented in hardware using integrated circuit development technologies, or yet via some other methods, or the combination of hardware and software objects that could be ordered, parameterized, and connected in a software environment to implement different functions described herein. For example, the present application may be implemented using a general purpose or dedicated processor running a software application through volatile or non-volatile memory. Also, the hardware objects could communicate using electrical signals, with states of the signals representing different data.

It should be further understood that this and other arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions, or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed:

1. A computer-implemented method of generating a user generated betting market in an online betting exchange, the online betting exchange comprising a plurality of exchange generated betting markets, the method being implemented in a computer comprising a processor and a memory in communication with the processor, the method comprising:
providing, by the processor, a user interface to a user of the betting exchange, the user interface allowing the user to input data associated with the user generated betting market to be generated;
receiving, as input to the processor, user input by the user interface; and
processing, by the processor, said user input to generate said user generated betting market.

2. A computer-implemented method according to claim 1, further comprising generating a user interface associated with said user generated betting market.

3. A computer-implemented method according to claim 1, wherein the input data includes a user commission, and wherein the user receives a value of at least some bets placed in said generated betting market based upon said user commission.

4. A computer-implemented method according to claim 1, wherein said user input indicates at least one exchange generated betting market upon which the user generated getting market is to be based, and wherein processing said user input to generate said user generated betting market comprises copying data from said at least one exchange generated betting market.

5. A computer-implemented method according to claim 4, wherein an outcome of said user generated betting market is determined based upon said at least one exchange generated betting market.

6. A computer-implemented method according to claim 1, wherein said user input data comprises an outcome for said user generated betting market and wherein said user generated betting market allows at least some users of the betting exchange to place bets on the outcome.

7. A computer-implemented method according to claim 6, wherein said user input data comprises a source for the result of the market.

8. A computer-implemented method according to claim 1, further comprising:
receiving, as input to the processor, access data indicating at least one user of the online betting exchange; and
restricting, by the processor, access to the user generated betting based upon said access data.

9. A computer-implemented method according to claim 6, wherein said access data comprises input from the user.

10. A computer-implemented method according to claim 6, further comprising generating, by the processor, identification data associated with the user generated betting market; and
wherein said access data indicating at least one user of the online betting exchange is generated based upon said identification data.

11. A computer-implemented method according to claim 1, wherein said user input data comprises data indicating a type of bet that can be placed by users of the user generated betting market.

12. A computer-implemented method according to claim 11, wherein said type of bet is a type selected from the group consisting of: a bet for an outcome, a bet against an outcome, a bet with only one other user, a bet with one or more other users.

13. A computer-implemented method according to claim 11, wherein said user input data comprises data indicating a first type of bet that can be placed by the user that generates said user generated betting market and a second, different type of bet that can be placed by other users of the user generated betting market.

14. A computer-implemented method according to claim 1, further comprising:
receiving, by the processor, market type data from said user; and
wherein said user interface comprises a template based upon said market type data.

15. A computer-implemented method according to claim 1, wherein said user generated betting market has an associated exchange commission, wherein the exchange receives a value of at least some bets placed in said generated betting market based upon said exchange commission, the method further comprising:
receiving a payment from the user in respect of the user generated betting market; and
reducing the exchange commission based upon the payment from the user.

16. A computer readable medium carrying a computer program comprising computer readable instructions configured to cause a computer to carry out a method according to claim 1.

17. A computer apparatus for generating a user generated betting market in an online betting exchange, the online betting exchange comprising a plurality of exchange generated betting markets, the apparatus comprising:
a memory storing processor readable instructions; and
a processor arranged to read and execute instructions stored in said memory;
wherein said processor readable instructions comprise instructions arranged to control the computer to carry out a method according to claim 1.
